(19) United States
(12) Patent Application Publication
(10) Pub. No.: US 2026/0065748 A1
(43) Pub. Date: Mar. 5, 2026

(54) MULTI-PLAYER VIDEO POKER GAME AND METHOD THEREOF

(71) Applicant: Clownfish Entertainment LLC, Henderson, NV (US)

(72) Inventors: Lawrence Vaughan, Las Vegas, NV (US); Stephen M Harris, Henderson, NV (US)

(73) Assignee: Clownfish Entertainment LLC, Henderson, NV (US)

(21) Appl. No.: 18/825,490

(22) Filed: Sep. 5, 2024

(51) Int. Cl. G07F 17/32

(52) U.S. Cl. CPC G07F 17/3258; G07F 17/3225; G07F 17/3272; G07F 17/3293

(57) ABSTRACT

A video poker game where a player selects from a variety of poker variants, including 5-Card Draw, Texas Hold'em, Omaha, 7-Card Stud, and 5-Card Stud. The player may choose to play alone or with other players. Each player places a wager to begin play, with a portion of the wager allocated to a primary pool and the remaining portion allocated to a secondary pool. Additional wagers, as dictated by the rules of the selected game, are also allocated to one or both of these pools. At the conclusion of the game, each player forms their best five-card poker hand. The player with the best hand compared to the other players is paid from the primary pool. Additionally, any player with a hand that matches a poker hand listed on a pay table is paid from the secondary pool. These games may also be dealt in an all-in style, where no player action is required beyond the initial wager, and/or in a single-handed style, where only one hand is played per game or tournament.

### REFERENCE TO RELATED APPLICATIONS

This application is related to U.S. Pat. No. 9,305,431, titled “MULTI-PLAYER VIDEO POKER GAME AND METHOD THEREOF,” filed on Sep. 17, 2013 in the name of the Applicants herein and issued on Apr. 5, 2016.

### TECHNICAL FIELD

This disclosure generally relates to a poker game, and more particularly, to a video poker game which may be played against other players where the wager and payouts are paid by the participating players minus a rake from each game.

### BACKGROUND

The card game of poker, with its many variations, has become an extremely popular form of entertainment. Poker is now a common social pastime for both gamblers and non-gamblers. One popular form of poker is video poker. Video poker is a video game based on five-card draw poker. It is generally played on a computerized console similar in size to a slot machine. Presently, video poker games are individual games. Thus, each player plays a hand against the house. The player's hand is generally compared to a payout schedule located on the computerized console. If the player has a winning hand based on the payout schedule, the player wins and the house makes the indicated payout. If the player has a losing hand based on the payout schedule, the house keeps the wager made by the player.

Unfortunately, presently, players cannot play against other players in present video poker consoles. If a video poker game would allow multiple players to play against one another, payouts could be made from opposing players and the house could take a rake based on the wagers from the players. It is therefore, desirable that a player would like to play against another player where the payout is paid from the opposing player and not from the house.

Therefore, it would be desirable to provide a card game and method that overcomes the above problems.

### SUMMARY

This summary is provided to introduce a selection of concepts in a simplified form that are further described below in the DESCRIPTION OF THE DISCLOSURE. This summary is not intended to identify key features of the claimed subject matter, nor is it intended to be used as an aid in determining the scope of the claimed subject matter.

A computer implemented video poker card game, the computer comprising a visual display device and a processor operably coupled to the display device and combined to display a card game, the processor programmed for a method comprising: inviting a plurality of players to play a video poker game, wherein each participating player plays an individual hand dealt from a standard 52 card deck; placing a wager to begin play by each participating player, wherein there is at least two participating players; dealing five cards to each participating player face up for that participating player, wherein each participating player may one of: hold, or replace any of the five cards; dealing replacement cards to each participating player who selects to replace any of the five cards dealt to that participating player; determining if any of the participating players has a winning wager by verifying if remaining five cards of each participating player matches a poker hand stated on a pay table; and paying each participating player having a winning wager from the wager placed by each participating player.

A game server has at least one processor and a memory operatively coupled to the at least one processor, the memory storing program instructions that when executed by the at least one processor causes the at least one processor to perform a method comprising: inviting a plurality of players to play a video poker game, wherein each participating player plays an individual hand dealt from a standard 52 card deck; placing a wager to begin play by each participating player, wherein there is at least two participating players; dealing five cards to each participating player face up, wherein each participating player may one of: hold, fold, or replace any of the five cards; dealing replacement cards to each participating player who selects to replace any of the five cards dealt to that participating player; determining if any of the participating players has a winning wager by verifying if remaining five cards of each participating player matches a poker hand stated on a pay table; and paying each participating player having a winning wager from the wager placed by each participating player.

A method of playing a video poker game comprising: inviting a plurality of players to play a video poker game, wherein each participating player plays an individual hand dealt from a standard 52 card deck; placing a wager to begin play by each participating player, wherein there is at least two participating players; dealing five cards to each participating player face up, wherein each participating player may one of: hold, fold, or replace any of the five cards; dealing replacement cards to each participating player who selects to replace any of the five cards dealt to that participating player; determining if any of the participating players has a winning wager by verifying if remaining five cards of each participating player matches a poker hand stated on a pay table; and paying each participating player having a winning wager from the wager placed by each participating player.

A computer implemented video poker card game, the computer comprising a visual display device and a processor operably coupled to the display device and combined to display a card game, the processor programmed for a method comprising: selecting a video poker game from a variety of offered video poker game variants; inviting a plurality of players to play the selected video poker game, wherein each participating player plays an individual hand dealt from a card deck; placing a wager to begin play by each participating player, wherein there is at least two participating players; allocating a first portion of the wager placed by each participating player into a primary pool; allocating a remaining portion of the wager placed by each participating player into a secondary pool; dealing a number of cards to each participating player from the card deck in accordance with rules of the selected video poker game; determining at conclusion of the video poker game which of the participating players has the best hand compared to the other participating players by comparing remaining five cards of each participating player; paying the participating player with the best hand compared to the other participating players from the primary pool; determining if any of the participating players has a winning wager by verifying if the remaining five cards of each participating player matches a poker hand stated on a pay table; paying each participating player having five cards that match a poker hand stated on the pay table from the secondary pool.

A game server comprising: at least one processor; and a memory operatively coupled to the at least one processor, the memory storing program instructions that when executed by the at least one processor causes the at least one processor to perform a method comprising: selecting a video poker game from a variety of offered video poker game variants; inviting a plurality of players to play the selected video poker game, wherein each participating player plays an individual hand dealt from a card deck; placing a wager to begin play by each participating player, wherein there is at least two participating players;
allocating a first portion of the wager placed by each participating player into a primary pool; allocating a remaining portion of the wager placed by each participating player into a secondary pool; dealing a number of cards to each participating player from the card deck in accordance with rules of the selected video poker game; determining at the end of the video poker game which of the participating players has the best hand compared to the other participating players by comparing remaining five cards of each participating player; paying the participating player with the best hand compared to the other participating players from the primary pool; determining if any of the participating players has a winning wager by verifying if the remaining five cards of each participating player matches a poker hand stated on a pay table; paying each participating player having five cards that match a poker hand stated on the pay table from the secondary pool.

A method for playing a video poker game comprising: selecting a video poker game from a variety of offered video poker game variants; inviting a plurality of players to play the selected video poker game, wherein each participating player plays an individual hand dealt from a card deck; placing a wager to begin play by each participating player, wherein there is at least two participating players; allocating a first portion of the wager placed by each participating player into a primary pool; allocating a remaining portion of the wager placed by each participating player into a secondary pool; dealing a number of cards to each participating player from the card deck in accordance with rules of the selected video poker game; determining at the end of the video poker game which of the participating players has the best hand compared to the other participating players by comparing remaining five cards of each participating player; paying the participating player with the best hand compared to the other participating players from the primary pool; determining if any of the participating players has a winning wager by verifying if the remaining five cards of each participating player matches a poker hand stated on a pay table; paying each participating player having five cards that match a poker hand stated on the pay table from the secondary pool.

The features, functions, and advantages can be achieved independently in various embodiments of the disclosure or may be combined in yet other embodiments.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a functional block diagram of the video poker system of the present invention;

FIG. 2 is a front view of a video poker console;

FIG. 3 is a functional block diagram of another embodiment of the video poker system of the present invention;

FIG. 4 is a flow chart showing operation of the video poker system of the present invention, wherein the video poker system offers a 52 card deck configuration of 5-card draw poker;

FIG. 5 is a flow chart showing operations of another embodiment of the video poker system of the present invention, wherein the video poker system offers various card deck configurations of 5-card draw poker; and

FIG. 6 is a flow chart showing operations of another embodiment of the video poker system of the present invention, wherein the video poker system offers various poker game variants and various card deck configurations.

### DESCRIPTION OF THE DISCLOSURE

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

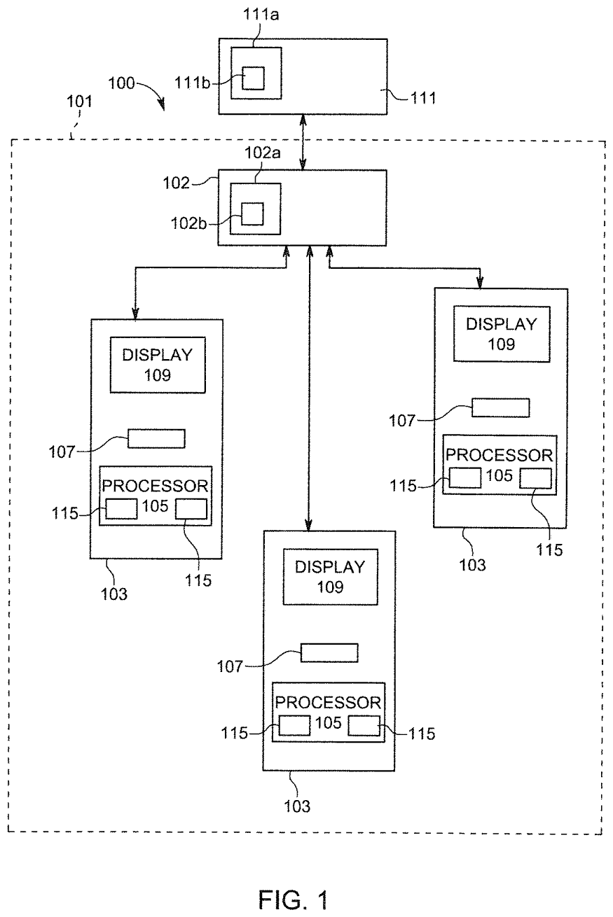

Referring to FIG. 1, one embodiment of a gaming system 100 for implementing the present invention is shown. The system 100 may enable multiple players to take part in a video poker game where the wager and payouts are paid to other players minus a rake from each game. The system 100 may run on a single gaming site/casino 101. Alternatively, the system 100 may run across multiple gaming sites/casinos 101. If the system 100 is run at a single gaming site/casino 101, the system 100 may include a local area server 102. The local area server 102 may be used to run the game on a plurality of gaming units 103. Alternatively, if multiple gaming sites 101 are included in the system 100, the system 100 may also include a central game server 111 to allow system wide communications, data collection, and control between or among gaming sites 101. The local area server 102 and the central game server 111 each include a processor 102a and 111a respectively. The processors 102a and 111a may be associated with memory 102b and 111b respectively which may be non-volatile memory, volatile memory, and/or both. The volatile and/or nonvolatile memory 102b and 111b may store computer program code that is executed by the processors 102b and 111b respectively to cause the processor to perform or direct the various functions for the gaming unit 103.

Each gaming unit 103 may include a processor 105 and a user interface arrangement including a player control arrangement 107 and a display device 109. The processor 105 may be associated with memory 115 which may be non-volatile memory, volatile memory, and/or both. The volatile and/or nonvolatile memory 115 may store computer program code that is executed by the processor 105 to cause the processor to perform or direct the various functions provided by the gaming unit 103. Each gaming unit 103 may further have a player input control 107. The player input control 107 may include various configurations of buttons, switches, pointing devices, and other devices that allow a player to make inputs during the course of a poker game. Display device 109 may include at least one video monitor/display such as a CRT, LCD, plasma, or other display device for displaying graphics in the course of game play. In particular, display device 109 displays various playing card representations as will be described in detail below. It will also be noted that player control functions may be integrated with display device 109 by using a touch screen display device. In these arrangements, the display screen itself, or more specifically, the touch sensitive film applied over the display screen and the controller associated with the touch-sensitive film, comprises part of player control arrangement 107.

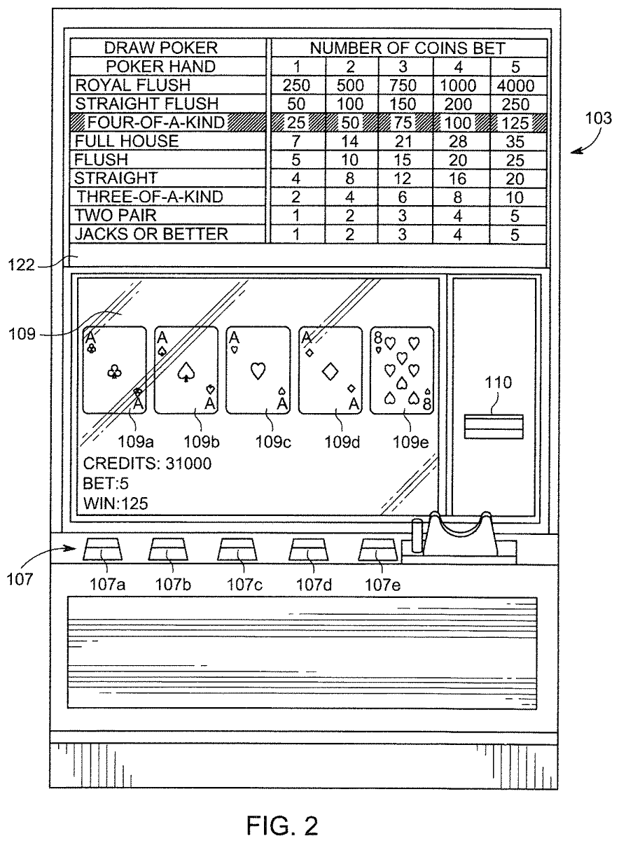

Referring to FIG. 2, one embodiment of a gaming unit 103 is shown. The gaming unit 103 may be used for playing the video poker game of the present invention. The gaming unit 103 may have a display device 109. The display device 109 may be used for displaying cards or other symbols at positions 109a-109e. In the present embodiment, the player input control 107 is a set of buttons 107a-107e. The buttons 107a-107e may be used as input buttons to hold and/or discard the displaying cards or other symbols at positions 109a-109e. As stated above, it should be understood that different inputs may also be used. For example, the display device 109 may be a touch screen and buttons may appear on the display screen under card positions 109a-109e or otherwise proximate to card positions 109a-109e.

The gaming unit 103 may further have a wager/payout device 110 for accepting wagers and making payouts to players. The wager/payout device 110 is typically a note acceptor-dispenser that accepts and validates currency inserted by the player, and for dispensing currency to a player for unused credits that are either unplayed or won during a play session. The wager/payout device 110 may also be configured to print tickets for an amount of credit available to the player when he no longer desires to play the machine.

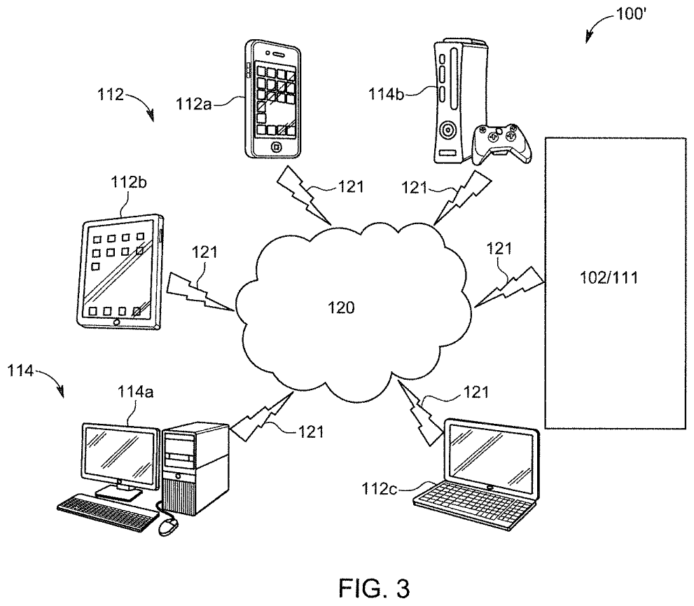

Referring now to FIG. 3, another embodiment of a gaming system 100′ for implementing the present invention is shown. The system 100′ may enable multiple players to take part in a video poker game where the wager and payouts are paid to other players minus a rake from each game. The system 100′ may be comprised of a plurality of mobile devices 112. The mobile devices 112 may be a cellular phone 112a, a tablet 112b, a laptop 112c or the like. The system 100′ may have other devices 114. These other devices 114 may include a desktop computer 114a, a gaming console 114b, or the like. The listing of the mobile devices 112 or other devices 114 is given as an example and should not be seen in a limiting manner. Any type of device may use the system 100′ as long as the device has a connection 121 to access the network system 120. The network system 120 may be a local-area network (LAN), wide-area network (WAN) or the Internet. The connection 121 may be a wired connection, a wireless connection, or the like. The mobile devices 112 and/or other devices 114 may then access the local area server 102 or the central game server 111, which ever server may be used for hosting the poker game.

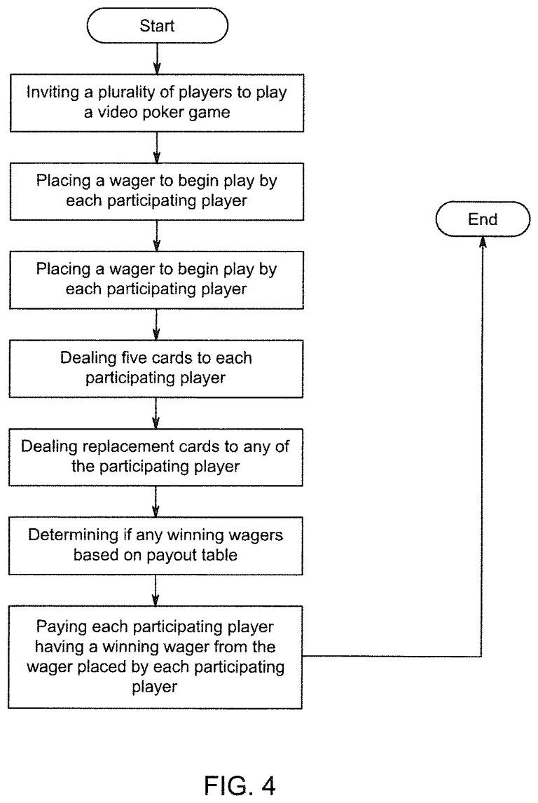

Referring now to FIG. 4, operation of the game will be disclosed. The operation of the game will be disclosed in regards to the system 100 of FIGS. 1 and 2. However, the game may be played on the system 100′ as well. The poker game of the present invention allows players to play individual poker games on the player's respective gaming unit 103. However, the system 100 allows players to play with other players playing individual poker on their respective gaming unit 103 such that each participating player's individual hands are compared to a payout table 122. Each player with a winning hand is then paid from the opposing player and not from the house. The house may take a rake based on the wagers by the participating players.

The game may be played with a standard deck of 52 cards used by all the players. However, a plurality of standard decks may be used per player or each player may have a separate 52 card deck. The game may be played with any number of players. For the present example, we will use five players. On the gaming unit 103, each player may first enter playable credits by placing currency, player's card etc. into the wager/payout device 110. Once credits have been entered into the gaming unit 103, the participating player may be asked if the player wishes to play as an individual (like current video poker games) or if the player wishes to play against other players.

When playing against multiple players, each participating player in the game is required to place a participation wager. The participation wager should be the exact same amount for each player and each participating player may be shown the exact same payout table 122 on their respective gaming unit 103 based on their respective poker hands. A rake may be taken by the house based on the amount wagered.

Once the participation wager is placed by each participating player, each player will receive five cards from a standard deck of cards. The five cards are generally displayed face up on the player's respective display device 109 on the gaming unit 103. Each participating player may then be asked to hold or replace each of the five cards to make the best possible poker hand. Each player may use buttons 107a-107e to hold and/or discard respective cards at positions 109a-109e. If a player elects to replace one, two, three, four or five cards, an additional card or cards will be dealt face up to the player to replace each card to form a final hand. If the player elects not to replace any cards the player is opting to play the original five cards dealt as the final hand.

If the five remaining cards, cause the player to have the highest hand versus the other players the player will receive a payout minus any rake from the primary pool. In addition, if any players final five cards, make a poker hand that matches a poker hand on the payout table 122, that player will receive the payout corresponding to that poker hand from the secondary pool.

The following would be a sample pay table of winning poker hands: Royal Flush 250, Straight Flush 50, Four of a Kind, 25, Full House 7, Flush 5, Straight 4, Three of a Kind 2, Two Pair 1 and Jacks or Better 1. The payout odds and possible winning hands listed are given as an example and should not be seen as to limit the scope of the present invention. In addition, the payout structure could include several different progressive pools. These progressive pools could be funded by a percentage of the initial wager by each player or a side bet. In addition, the house could fund payouts on certain hands by a promotion or contributing to any of the pools. The rake percentage could be any percentage amount that will be determined by the operator.

The game would be played as follows. Each participating player places a participation wager of $1.00. In the present example, there will be five participating players. Thus, a total of $5.00 is placed in the pot. The $5.00 pot would be distributed as follows: $2.50 would go to the primary pool to pay the winner of the best poker band of the five players, $0.50 would go to the operator for the rake, and the remaining $2.00 would go to the secondary pool to pay any payouts a player bits on the payout table. Player 1 receives the following five cards from a card deck: Ace of hearts, jack of hearts, seven of hearts, six of hearts and two of clubs. Player 1 holds the first four cards and replaces the fifth card, the two of clubs. Player I receives the two of spades making his best hand as Ace high. Player 2 is dealt a Jack of Hearts, Jack of Clubs, Three of Spades, Two of Clubs and Nine of Hearts. Player 2 decides to hold the pair of Jacks and discard his last three cards. The player receives the Seven of Clubs, Nine of Clubs, and Queen of Clubs. Player 2 automatically wins a $1.00 from the secondary pool for having a pair of Jacks. Player 3, Player 4 and Player 5 hold and discard cards but don't make a winning hand based on the payout table. Therefore, Player 2 wins an additional $2.50 from the primary pool for the best poker hand. The remaining $1.00 is added to the secondary pool.

In accordance with another embodiment, the above could be played wherein a participating player has the option to fold. Thus, once the participation wager is placed by each participating player, each player will receive five cards from a 52 card deck of cards. Each participating player may have the option to fold to lose a portion of the participating wager.

In addition, the game could be played by each player requesting to play a multi hand version of the game. In this example, two players desire to play against each other. If all the players select to play a two hand multi version of the game, the player would make a $1.00 wager per hand, $2.00 per player for a total of $4.00. Player I would receive five cards exposed from a standard 52 card deck in his/her first hand, the same five cards exposed would be dealt in the second hand from the same 52 card deck for each hand. In this example the five cards are a jack of diamonds, three of spades, four of hearts, nine of clubs and two of spades. The player then would select to hold or replace the five cards. In this example, Player 1 selects to hold only the jack of diamonds and replace the other four cards. Therefore, the dealer would deal four cards from the standard 52 card decks. The results are as follows with a rake percentage set at 10% for purposes of this example:

### Original Hand

Hand 1: Jack of Diamonds, Three of Spades, Four of Hearts, Nine of Clubs and Two of Spades
Hand 2: Jack of Diamonds, Three of Spades, Four of Hearts, Nine of Clubs and Two of Spades

Player 1 elects to hold only the Jack of Diamonds and draws four new cards for each hand. After the draw, each hand is now as follows:
Hand 1: Jack of Diamonds, Ten of Clubs, Nine of Hearts, Ace of Clubs, King of Spades
Hand 2: Jack of Diamonds, Six of Clubs, Six of Spades, Queen of Spades, Jack of Clubs

Player 1 wins on Hand 2, $1.00 dollar for making a pair of Jacks from the secondary pool. Again, the payout odds and amount wagered are given as an example and should not be seen as to limit the scope of the present invention.

Player 2 is dealt two losing hands that do not make a payout on the paytable. Therefore, Player 1 wins $2.00 from the primary pool for having the highest poker hand and the operator receives $0.40 cents for the rake and the remaining $0.60 is added to the secondary pool for the next hand.

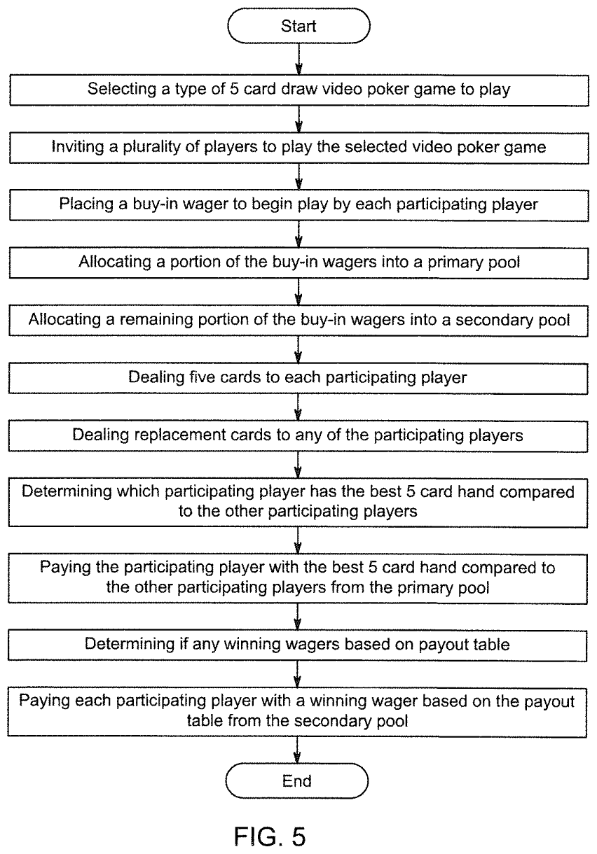

Referring to FIG. 5, another embodiment of the operation of the game will be disclosed. The operation of the game will be disclosed in regards to the system 100 of FIGS. 1 and 2. However, the game may be played on the system 100′ as well. In this embodiment, the multi-player poker game system 100 allows players to engage in a card deck configuration variant of 5-card draw poker; e.g. standard 52 card decks, 36 card short decks, and combinations thereof, while offering two distinct ways to win. Particularly, the system's 100 innovative payout structure allows players to win by either having the best hand compared to other players or by meeting specific conditions outlined in the dynamic payout table 122. The system 100 allows for various card deck configurations including standard 52 card decks, each player receiving their own standard 52 card deck per hand, multiple standard 52 cards, 36 card short decks, and their combinations. The system 100 also allows for options for playing with a single deck shared among participating players or for playing with a unique deck provided to each participating player. It also provides for the integration of multiple decks shuffled together and for the dealing of multiple hands to players. Players can opt to be dealt multiple five-card hands simultaneously. Wild cards may also be incorporated into any deck configuration. Each type of poker game offered on the system 100 will have its own unique settings that include deck configuration, wild card usage, and specialized payout structures.

On the gaming unit 103, each player may first enter playable credits by placing currency, player's card etc. into the wager/payout device 110. Once credits have been entered into the gaming unit 103, the participating player may be asked to select the type of poker game he wishes to play; e.g. 52 card 5-card draw, 36 card 5-card draw, and whether wild cards will be in play. Next, the participating player may be asked if the player wishes to play as an individual (like current video poker games) or if the player wishes to play against other players.

When playing against multiple players, each participating player in the game is required to place a participation wager (i.e. buy-in wager). The participation wager could be the exact same amount for each player and each participating player may be shown the payout table based on the amount of the participation wager 122 on their respective gaming unit 103 based on their respective poker hands. A rake may be taken by the house based on the amount wagered in a similar manner as described above with respect to FIG. 4. All of the buy-in wagers are then allocated into a first pool (primary pool) and into a second pool (secondary pool). The buy-in wagers are allocated into the primary pool and secondary pool according to pre-set configurations for the specific type of 5-card draw poker game that was selected. The primary pool is used for payouts to the participating player with the best poker hand as compared to the other participating players. The best poker hand is determined according to the rules of the 5-card draw poker game that was selected. The secondary pool is designated for additional payouts for any participating player having a poker hand that matches certain outcomes on the payout table 122.

Once the participation wager is placed by each participating player, each player will receive five cards from either the shared deck or their own 52 card standard deck of cards, depending on the five-card draw poker variation that was selected. The five cards are generally displayed face up on the player's respective display device 109 on the gaming unit 103. Each participating player may then be asked to hold or replace each of the five cards to make the best possible poker hand. Each player may use buttons 107a-107e to hold and/or discard respective cards at positions 109a-109e. If a player elects to replace one, two, three, four or five cards, an additional card or cards will be dealt face up to the player to replace each card replaced from their own 52 card deck to form a final hand. If the player elects not to replace any cards the player is opting to play the original five cards dealt as the final hand.

At the end of the poker game, the system 100 evaluates all of the poker hands against each other. The player with the best hand as compared to the other players is then paid from the primary pool according to pre-set configurations for the specific type of 5-card draw poker game that was selected. The best hand is determined according to the rules of the 5-card draw poker game that was selected. The system 100 then evaluates all of the poker hands of the participating players against the payout table 122 and pays any participating player with a winning hand with money from the secondary pool based on the payout table. The payout will come from the secondary pool, wherein the secondary pool may be defined as all player wagers by the player minus the rake.

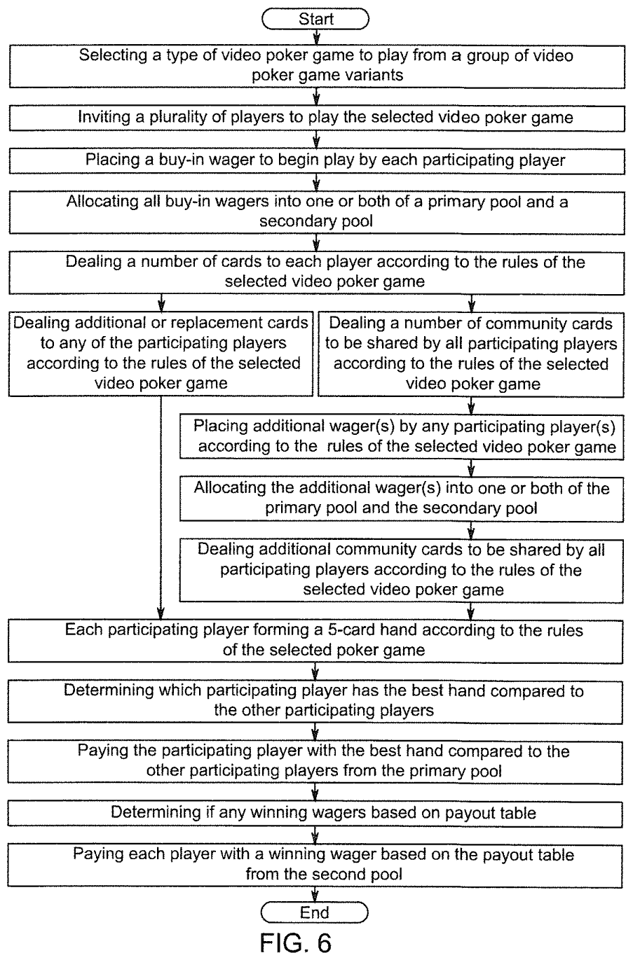

Referring to FIG. 6, another embodiment of the operation of the game will be disclosed. The operation of the game will be disclosed in regards to the system 100 of FIGS. 1 and 2. However, the game may be played on the system 100′ as well. In this embodiment, the multi-player poker game system 100 allows players to engage in any type of poker game variant, e.g. 5-card draw, Texas Hold'em, Omaha, 7 Card Stud, 5 card stud etc., while offering two distinct ways to win. Particularly, the system's 100 innovative payout structure allows players to win by either having the best hand compared to other players or by meeting specific conditions outlined in the dynamic payout table 122. The system 100 allows for various card deck configurations including standard 52 card decks, individual decks per player, multiple decks, 36 card short decks, short decks, and their combinations. The system 100 also allows for options for playing with a single deck shared among participating players or for playing with a unique deck provided to each participating player. It also provides for the integration of multiple decks shuffled together and for the dealing of multiple hands to players. Wild cards may also be incorporated into any deck configuration. Each type of poker game offered on the system 100 will have its own unique settings that include deck configuration, wild card usage, and specialized payout structures.

On the gaming unit 103, each player may first enter playable credits by placing currency, player's card etc. into the wager/payout device 110. Once credits have been entered into the gaming unit 103, the participating player may be asked to select the type of poker game he wishes to play from a group of video poker game variants; e.g. 5-card draw (standard 52 card decks, 36 card short decks, and their combinations), Texas Hold'em, Omaha, Stud, etc. Next, the participating player may be asked if the player wishes to play as an individual (like current video poker games) or if the player wishes to play against other players.

When playing against multiple players, each participating player in the game is required to place a participation wager (i.e. buy-in wager). The participation wager could be the exact same amount for each player and each participating player would be shown a payout table based on their among to the participation wager 122 on their respective gaming unit 103 based on their respective poker hands. A rake may be taken by the house based on the amount wagered in a similar manner as described above with respect to FIG. 4. All of the buy-in wagers are then allocated into a first pool (primary pool) and into a second pool (secondary pool). The buy-in wagers are allocated into the primary pool and secondary pool according to pre-set configurations for the specific type of poker game that was selected. The primary pool is used for payouts to the participating player with the best poker hand as compared to the other participating players. The best poker hand is determined according to the rules of the selected video poker game variant. The secondary pool is designated for additional payouts for any participating player having a poker hand that matches certain outcomes on the payout table 122.

Once the participation wager is placed by each participating player, each player is dealt cards as per the rules of the selected video poker game. For example, if 5-card draw poker is selected, each player would be dealt five cards, with options to hold or replace cards to form the strongest possible hands. If 7 card stud poker was selected, the poker rules could require each player to initially be dealt two face-down cards and one face-up card and will subsequently be dealt three more face-up cards (one face-up card in each additional dealing round) and one more face-down card in a final round of dealing-allowing for another round of betting in between each dealing round and after the final dealing round. If Omaha poker was selected, then poker rules could require each player to be dealt four cards face down and three community cards will be dealt face-up (the flop), followed by a fourth community card being dealt (the turn), and finished with a fifth community card being dealt (the river)-allowing for an additional round of betting in between each dealing round and after the river community card is dealt. If Texas Hold'em poker was selected, the poker rules could require each player to be dealt two cards face down and three community cards will be dealt face-up (the flop), followed by a fourth community card being dealt (the turn), and finished with a fifth community card being dealt (the river)-allowing for an additional round of betting in between each dealing round and after the river community card is dealt. If 5 card stud poker was selected, the poker rules might require each player to be dealt five cards face up at once with no additional wagers. Any additional wagers that are placed by the participating players will also be allocated into the primary and secondary pools according to pre-set configurations for the specific type of poker game that was selected. In any of the selected video game poker variants, when an additional round of betting is permitted, each participating player will be permitted to raise (make an additional wager), call (match the additional wager made by another participating player and remain in the current game), or fold (refuse to match the additional wager made by another participating player and cease to continue with the current hand). Whether these additional wagers may be made and how these additional wagers may be made will be dictated by the rules of the selected video poker game.

At the end of the poker game, each player will have formed a 5-card poker hand according to the rules of the selected video poker game. The system 100 evaluates all of the poker hands against each other. The player with the best hand as compared to the other players is then paid from the primary pool according to pre-set configurations for the specific type of poker game that was selected. The best hand is determined according to the rules of the selected video poker game. The system 100 then evaluates all of the poker hands against the payout table 122 and pays any player with a winning hand with money from the secondary pool based on the payout table. The payout will come from the secondary pool, wherein the secondary pool may be defined as all player wagers by the player minus the rake, minus the wagers allocated to the primary pool.

It should be noted that this invention should not be limited in scope by one hand per player, three hands, five hands, ten hands or one hundred hands per player. In addition, it should not be limited by the number of pools.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A computer implemented video poker card game, the computer comprising a visual display device and a processor operably coupled to the display device and combined to display a card game, the processor programmed for a method comprising:
selecting a video poker game from a variety of offered video poker game variants;
inviting a plurality of players to play the selected video poker game, wherein each participating player plays an individual hand dealt from a standard 52 card deck;
placing a wager to begin play by each participating player, wherein there is at least two participating players;
allocating a first portion of the wager placed by each participating player into a primary pool;
allocating a remaining portion of the wager placed by each participating player into a secondary pool;
dealing a number of cards to each participating player from the card deck in accordance with rules of the selected video poker game;
determining at conclusion of the video poker game which of the participating players has the best hand compared to the other participating players by comparing remaining five cards of each participating player;
paying the participating player with the best hand compared to the other participating players from the primary pool;
determining if any of the participating players has a winning wager by verifying if the remaining five cards of each participating player matches a poker hand stated on a pay table;
paying each participating player having five cards that match a poker hand stated on the pay table from the secondary pool.

2. The computer implemented video poker card game of claim 1, wherein the selected video poker game is 5 card draw and the step of dealing a number of cards to each participating player from the card deck in accordance with rules of the selected video poker game further comprises the steps of:
dealing five cards to each participating player face up from the card deck, wherein each participating player may hold or replace any of the five cards; and
dealing replacement cards to each participating player from the card deck for each participating player who selects to replace any of the five cards dealt to that participating player.

3. The computer implemented video poker card game of claim 1, wherein the selected video poker game is 7 card stud and the step of dealing a number of cards to each participating player from the card deck in accordance with the rules of the selected video poker game further comprises the steps of:
firstly dealing of two cards face down and one card face up from the card deck; and
secondly dealing of one card face up from the card deck;
thirdly dealing of one card face up from the deck;
fourthly dealing of one card face up from the deck;
fifthly dealing of one card face down from the deck;
wherein any participating player may place an additional wager after any dealing step;
wherein the additional wager is allocated to at least one of the primary pool and the secondary pool.

4. The computer implemented video poker card game of claim 1, wherein the selected video poker game is Omaha and the step of dealing a number of cards to each participating player from the card deck in accordance with the rules of the selected video poker game further comprises the steps of:
firstly dealing four cards face down to each participating player from the card deck;
secondly dealing three community cards face up from the card deck;
thirdly dealing a fourth community card face up from the card deck; and
fourthly dealing a fifth community card face up from the card deck,
wherein any participating player may place an additional wager before the three community cards are dealt,
wherein any participating player may place an additional wager between the dealing of the three community cards and the dealing of the fourth community card,
wherein any participating player may place an additional wager between the dealing of the fourth community card and the dealing of the fifth community card, and
wherein any participating player may place an additional wager after the dealing of the fifth community card, and
wherein the additional wager is allocated to at least one of the primary pool and the secondary pool.

5. The computer implemented video poker card game of claim 1, wherein the selected video poker game is Texas Hold'em and the step of dealing a number of cards to each participating player from the card deck in accordance with the rules of the selected video poker game further comprises the steps of:
firstly dealing two cards face down to each participating player from the card deck;
secondly dealing three community cards face up from the card deck;
thirdly dealing a fourth community card face up from the card deck; and
fourthly dealing a fifth community card face up from the card deck,
wherein any participating player may place an additional wager before the three community cards are dealt,
wherein any participating player may place an additional wager between the dealing of the three community cards and the dealing of the fourth community card,
wherein any participating player may place an additional wager between the dealing of the fourth community card and the dealing of the fifth community card, and
wherein any participating player may place an additional wager after the dealing of the fifth community card, and
wherein the additional wager is allocated to at least one of the primary pool and the secondary pool.

6. The computer implemented video poker card game of claim 1, wherein the selected video poker game is 5 card stud and the step of dealing a number of cards to each participating player from the card deck in accordance with the rules of the selected video poker game further comprises the steps of:
firstly dealing five cards face up from the card deck; and
wherein there are no additional wagers or options.

7. The computer implemented video poker card game of claim 1, wherein paying each participating player having a winning wager further comprises paying each participating player having a winning wager from the wager placed by each participating player after a rake is taken from the wager placed by each participating player by an organizer.

8. The computer implemented video poker card game of claim 1, wherein paying each participating player having a winning wager from the wager placed by each participating player further comprises paying a proportional share of the winning wager by each remaining participating player having a non-winning wager.

9. A game server comprising:
at least one processor; and
a memory operatively coupled to the at least one processor, the memory storing program instructions that when executed by the at least one processor causes the at least one processor to perform a method comprising:
selecting a video poker game from a variety of offered video poker game variants;
inviting a plurality of players to play the selected video poker game, wherein each participating player plays an individual hand dealt from a standard 52 card deck;
placing a wager to begin play by each participating player, wherein there is at least two participating players;
allocating a first portion of the wager placed by each participating player into a primary pool;
allocating a remaining portion of the wager placed by each participating player into a secondary pool;
dealing a number of cards to each participating player from the card deck in accordance with rules of the selected video poker game;
determining at the end of the video poker game which of the participating players has the best hand compared to the other participating players by comparing remaining five cards of each participating player;
paying the participating player with the best hand compared to the other participating players from the primary pool;
determining if any of the participating players has a winning wager by verifying if the remaining five cards of each participating player matches a poker hand stated on a pay table; and
paying each participating player having five cards that match a poker hand stated on the pay table from the secondary pool.

10. The game server of claim 9, wherein the selected video poker game is 5 card draw and the step of dealing a number of cards to each participating player from the card deck in accordance with rules of the selected video poker game further comprises the steps of:
dealing five cards to each participating player face up from the card deck, wherein each participating player may hold or replace any of the five cards; and
dealing replacement cards to each participating player from the card deck for each participating player who selects to replace any of the five cards dealt to that participating player.

11. The game server of claim 9, wherein the selected video poker game is 7 card stud and the step of dealing a number of cards to each participating player from the card deck in accordance with the rules of the selected video poker game further comprises the steps of:
firstly dealing of two cards face down and one card face up from the card deck; and
secondly dealing of one card face up from the card deck;
thirdly dealing of one card face up from the deck;
fourthly dealing of one card face up from the deck;
fifthly dealing of one card face down from the deck;
wherein any participating player may place an additional wager after any dealing step; and
wherein the additional wager is allocated to at least one of the primary pool and the secondary pool.

12. The game server of claim 9, wherein the selected video poker game is Omaha and the step of dealing a number of cards to each participating player from the card deck in accordance with the rules of the selected video poker game further comprises the steps of:
firstly dealing four cards face down to each participating player from the card deck;
secondly dealing three community cards face up from the card deck;
thirdly dealing a fourth community card face up from the card deck; and
fourthly dealing a fifth community card face up from the card deck,
wherein any participating player may place an additional wager before the three community cards are dealt,
wherein any participating player may place an additional wager between the dealing of the three community cards and the dealing of the fourth community card,
wherein any participating player may place an additional wager between the dealing of the fourth community card and the dealing of the fifth community card, and
wherein any participating player may place an additional wager after the dealing of the fifth community card, and
wherein the additional wager is allocated to at least one of the primary pool and the secondary pool.

13. The game server of claim 9, wherein the selected video poker game is Texas Hold'em and the step of dealing a number of cards to each participating player from the card deck in accordance with the rules of the selected video poker game further comprises the steps of:
firstly dealing two cards face down to each participating player from the card deck;
secondly dealing three community cards face up from the card deck;
thirdly dealing a fourth community card face up from the card deck; and
fourthly dealing a fifth community card face up from the card deck,
wherein any participating player may place an additional wager before the three community cards are dealt,
wherein any participating player may place an additional wager between the dealing of the three community cards and the dealing of the fourth community card,
wherein any participating player may place an additional wager between the dealing of the fourth community card and the dealing of the fifth community card, and
wherein any participating player may place an additional wager after the dealing of the fifth community card, and
wherein the additional wager is allocated to at least one of the primary pool and the secondary pool.

14. The game server of claim 9, wherein the selected video poker game is 5 card stud and the step of dealing a number of cards to each participating player from the card deck in accordance with the rules of the selected video poker game further comprises the steps of:
firstly dealing five cards face up from the card deck; and
wherein there are no additional wagers or options.

15. The game server of claim 9, wherein paying each participating player having a winning wager further comprises paying each participating player having a winning wager from the wager placed by each participating player after a rake is taken from the wager placed by each participating player by an organizer.

16. The game server of claim 9, wherein paying each participating player having a winning wager from the wager placed by each participating player further comprises paying a proportional share of the winning wager by each remaining participating player having a non-winning wager.

17. A method for playing a video poker game comprising:
selecting a video poker game from a variety of offered video poker game variants;
inviting a plurality of players to play the selected video poker game, wherein each participating player plays an individual hand dealt from a standard 52 card deck;
placing a wager to begin play by each participating player, wherein there is at least two participating players;
allocating a first portion of the wager placed by each participating player into a primary pool;
allocating a remaining portion of the wager placed by each participating player into a secondary pool;
dealing a number of cards to each participating player from the card deck in accordance with rules of the selected video poker game;
determining at the end of the video poker game which of the participating players has the best hand compared to the other participating players by comparing remaining five cards of each participating player;
paying the participating player with the best hand compared to the other participating players from the primary pool;
determining if any of the participating players has a winning wager by verifying if the remaining five cards of each participating player matches a poker hand stated on a pay table;
paying each participating player having five cards that match a poker hand stated on the pay table from the secondary pool.

18. The method of claim 17, wherein paying each participating player having a winning wager further comprises paying each participating player having a winning wager from the wager placed by each participating player after a rake is taken from the wager placed by each participating player by an organizer.

19. The method of claim 17, wherein paying each participating player having a winning wager from the wager placed by each participating player further comprises paying a proportional share of the winning wager by each remaining participating player having a non-winning wager, with each wager contributing to both the primary pool and additional pool(s) according to the game's configuration.

20. The game server of claim 9, wherein the selected video poker game may be dealt in an all-in style, such that all participating players are automatically committed to the maximum wager from the start, with no further player actions required after the initial wager.

21. The game server of claim 9, wherein the selected video poker game may be played in a single-handed style, where only one hand is dealt per game or tournament, and the outcome is determined solely based on the results of this single hand.
